(19) United States
(12) Patent Application Publication
(10) Pub. No.: US 2012/0059901 A1
(43) Pub. Date: Mar. 8, 2012

(54) SYSTEM AND METHOD FOR PROVIDING SOCIAL NETWORKING CONTENT IN WIDGET

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/163,751

(22) Filed: Jun. 20, 2011

(30) Foreign Application Priority Data
Sep. 2, 2010 (CN) 201010270612.4

(51) Int. Cl. G06F 15/16

(52) U.S. Cl. 709/217

(57) ABSTRACT

A system for providing social networking content in a widget includes a detection module, an authentication module, a receiving module, and a presenting module. The detection module detects an event associated with updating social networking content in the widget. The authentication module generates a request for authenticating a member identifier of a social network service. The receiving module receives, from the social network service, social networking content associated with the member identifier. The presenting module presents the social networking content in the widget.

### BACKGROUND

1. Technical Field

The disclosure generally relates to a system and method for providing social networking content in a widget of an electronic device.

2. Description of Related Art

A widget refers to a small personal program used in computing system such as a personal computer or a mobile device, which enables easy access to frequently used functions or delivers certain visual information. Recently, the widget is being considered further because it can provide social networking content from a social networking service (SNS) site, such as FACEBOOK®, TWITTER®, or the like. In a conventional manner, however, a user have to manually control the widget to update or refresh the social networking content when the user wants to get real-time messages.

Accordingly, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a widget system installed in an electronic device.

FIG. 2 is a flowchart of a method of providing social networking content using the widget system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

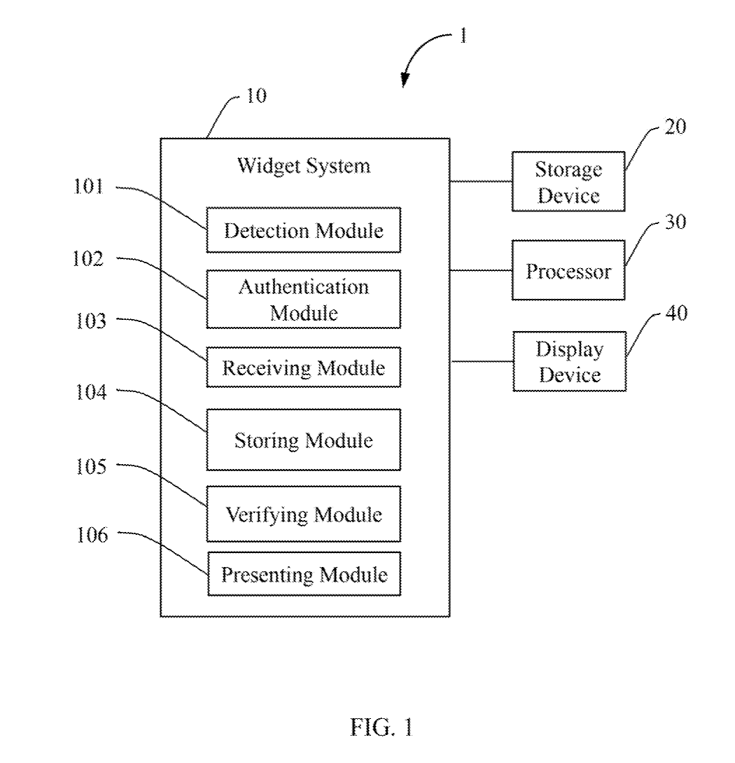

FIG. 1 is a schematic diagram of one embodiment of an electronic device 1. In the embodiment, the electronic device 1 may include a widget system 10, a storage device 20, at least one processor 30, and a display device 40. The widget system 10 may provide social networking content in a widget displayed in the display device 40 of the electronic device 1. One or more computerized codes of the widget system 10 are stored in the storage device 20 and executed by the at least one processor 30. The display device 40 is operable to display one or more widgets.

In one embodiment, the storage device 20 may be a magnetic or an optical storage system, such as a hard disk drive, an optical drive, or a tape drive. The storage device 20 also stores corresponding social networking content received by the widget system 10. The display device 40 is configured with a display screen, such as a liquid crystal display (LCD) or a cathode-ray tube (CRT) display.

In one embodiment, the widget system 10 includes a detection module 101, an authentication module 102, a receiving module 103, a storing module 104, a verifying module 105, and a presenting module 106. Each of the modules 101-106 may be a software program including one or more computerized instructions that are stored in the storage device 20 and executed by the processor 30.

The detection module 101 may detect an event associated with updating social networking content in the widget. An event can be, for example, a timer triggers every few minutes. Another event can be a detection of a user instruction, for example, by clicking an update button in a user interface (UI) of the widget system 10.

The authentication module 102 may generate a request for authenticating a member identifier (e.g., alias, user name, user identification, etc. representing a member) of a social network service.

The receiving module 103 may receive, from the social network service, social networking content associated with the member identifier. The social networking content may include a plurality of articles, such as a message from a friend, a piece of weather forecast, or a record of location information. An article can include textual, pictorial, visual still or moving images, and/or audio content.

The storing module 104 may store the social networking content in the storage device 20. In one embodiment, the storing module 104 can be configured to allocate an expiring time associated with the social networking content to indicate when the social networking content expires. In this embodiment, an event associated with updating social networking content, can be a detection that the social networking content expires.

The verifying module 105 may verify whether one or more images included in the social networking content is valid to be presented in the widget. If an invalid image is determined, the verifying module 105 replaces the invalid image with a default image.

The presenting module 106 may present the social networking content in the widget on a display screen of the display device 40. The presenting module 106 can present a few of articles of the social networking content once in the widget according to the size of the widget.

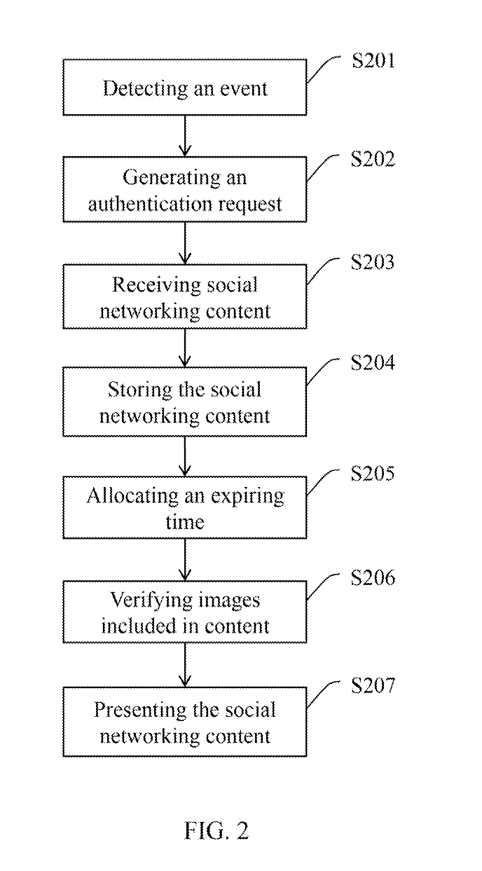

FIG. 2 is a flowchart illustrating one embodiment of a method of providing social networking content using the widget system of FIG. 1. The method may include the following steps.

In step S201, the detection module 101 detects an event associated with updating social networking content in the widget.

In step S202, the authentication module 102 generates a request for authenticating a member identifier (e.g., alias, user name, user identification, etc. representing a member) of a social network service.

In step S203, the receiving module 103 receives, from the social network service, social networking content associated with the member identifier.

In step S204, the storing module 104 stores the social networking content in the storage device 20.

In step S205, the storing module 105 allocates an expiring time associated with the social networking content to indicate when the social networking content expires.

In step S206, the verifying module 105 verifies whether one or more images included in the social networking content is valid to be presented in the widget. If an invalid image is determined, the verifying module 105 replaces the invalid image with a default image.

In step S207, the presenting module 106 presents the social networking content in the widget on a display screen of the display device 40.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-implemented method of providing social networking content in a widget of an electronic device, comprising:
detecting an event associated with updating social networking content in the widget;
generating a request for authenticating a member identifier of a social network service;
receiving, from the social network service, social networking content associated with the member identifier; and
presenting the social networking content in the widget on a display screen of the electronic device.

2. The method of claim 1, further comprising a storing step after the receiving step the storing step comprising:
storing the social networking content in a storage device of the electronic device;
allocating an expiring time associated with the social networking content to indicate when the social networking content expires.

3. The method of claim 2, wherein the event is a detection that the social networking content expires.

4. The method of claim 1, wherein the social networking content comprises a plurality of articles associated with the social network service.

5. The method of claim 1, wherein the event is a timer triggers every a predetermined period of time.

6. The method of claim 1, wherein the event is a detection of a user instruction in the widget.

7. The method of claim 1, further comprising:
determining an invalid image included in the social networking content; and
replacing the invalid image with a default image.

8. A system for providing social networking content in a widget of an electronic device, comprising:
a detection module adapted to detect an event associated with updating social networking content in the widget;
an authentication module adapted to generate a request for authenticating a member identifier of a social network service;
a receiving module adapted to receive, from the social network service, social networking content associated with the member identifier; and
a presenting module adapted to present the social networking content in the widget on a display screen of the electronic device.

9. The system of claim 8, further comprising a storing module adapted to store the social networking content in a storage device of the electronic device.

10. The system of claim 9, wherein the storing module is further adapted to allocate an expiring time associated with the social networking content to indicate when the social networking content expires.

11. The system of claim 10, wherein the event is a detection that the social networking content expires.

12. The system of claim 8, wherein the social networking content comprises a plurality of articles associated with the social network service.

13. The system of claim 8, wherein the event is a timer triggers every a predetermined period of time.

14. The system of claim 8, wherein the event is a detection of a user instruction in the widget.

15. The system of claim 8, further comprising a verifying module adapted to determine an invalid image included in the social networking content, replace the invalid image with a default image.

16. A non-transitory storage medium having stored thereon instructions that, when executed by a processor of an electronic device, cause the electronic device to perform a method, the method comprising:
detecting an event associated with updating social networking content in the widget;
generating a request for authenticating a member identifier of a social network service;
receiving, from the social network service, social networking content associated with the member identifier; and
presenting the social networking content in the widget on a display screen of the electronic device.

17. The storage medium of claim 16, wherein the method further comprises a storing step after the receiving step, the storing step comprising:
storing the social networking content in a storage device of the electronic device;
allocating an expiring time associated with the social networking content to indicate when the social networking content expires.

18. The storage medium of claim 17, wherein the event is a detection that the social networking content expires.

19. The storage medium of claim 16, wherein the method further comprises:
determining an invalid image included in the social networking content; and
replacing the invalid image with a default image.

20. The storage medium of claim 16, wherein the event is a timer triggers every a predetermined period of time.
